(19) United States
(12) Patent Application Publication
(10) Pub. No.: US 2023/0141546 A1
(43) Pub. Date: May 11, 2023

(54) GRAPHENE HEATING MAT

(71) Applicant: Farrpro, Inc., Iowa City, IA (US)

(72) Inventors: Amos Isaac Petersen, Iowa City, IA (US); Steven James Hoff, Iowa City, IA (US); Benjamin Carl Smith, Iowa City, IA (US); Cameron Jesse Smith, Iowa City, IA (US); James Donald Riley, Iowa City, IA (US)

(21) Appl. No.: 17/983,122

(22) Filed: Nov. 8, 2022

Related U.S. Application Data
(60) Provisional application No. 63/277,658, filed on Nov. 10, 2021.

(51) Int. Cl. A01K 1/015; H05B 3/14; H05B 3/36; H05B 3/18

(52) U.S. Cl. CPC A01K 1/0158; H05B 3/145; H05B 3/36; H05B 3/18; A01K 1/0157; H05B 2203/013; H05B 2203/032

(57) ABSTRACT

A heating mat system is presented for use with livestock. The heating mat system includes a heating layer positioned between an upper support pad and a lower support pad. The heating layer includes a conductive microfilm that has a generally planar shape extending between a front edge, a rear edge, and opposing side edges. In one or more arrangements, the conductive microfilm includes a layer of graphene. In one or more arrangements, the heating mat system has a first electrical contact and a second electrical contact that are connected to the conductive microfilm. When a voltage difference is applied between the first electrical contact and the second electrical contact, current flows through the conductive microfilm, thereby generating heat to the heating mat system and heating livestock positioned on the system.

### CROSS REFERENCE TO RELATED APPLICATIONS

The present application claims priority to U.S. Provisional Application 63/277,658, titled GRAPHENE HEATING MAT, and filed on Nov. 10, 2021, the entirety of which is hereby incorporated by reference herein, including any figures, tables, drawings, or other information.

### FIELD OF THE DISCLOSURE

This disclosure relates generally to heating elements. More specifically, and without limitation, this disclosure relates generally to heating mats.

### OVERVIEW OF THE DISCLOSURE

Heating systems are used in modern agriculture to provide warmth for livestock in colder temperatures. For example, in farrowing of swine, it is frequently desirable to provide piglets with supplemental heat without overheating, and thereby stressing, the sow. However, due to their much higher surface area to volume ratios, more external heat needs to be applied to the piglets than to the sow to keep all of the animals at the optimum temperature. Failure to provide piglets with sufficient external heat may lead to the death of some piglets from chilling, starvation, and disease. While piglets may lie against the sow for warmth, this increases the chances of the sow rolling over and suffocating or crushing the piglets.

Some heating systems for farrowing provide a farrowing crate with separate sow and piglet areas separated by a fence. The piglet area is provided with a heat lamp and/or heat mat to draw the piglets away from the sow to avoid injury or death associated with crushing. Providing separate heating elements for the piglet area draws and warms the piglets without overheating the sow. The fence is provided with metal fingers or other barriers to allow the piglets to pass back and forth between the sow and piglet areas for feeding and heating, while preventing the sow from moving into the piglet area and crushing the piglets.

Some livestock heating systems utilize heat lamps to generate heat. However, heat lamps generally do not distribute heat uniformly but rather radiate heat isotropically, creating a heating pattern of concentric bands that increase in temperature toward a point directly below the heat lamp. The heating pattern therefore presents a thermal gradient, with temperatures on the outer boundary of the heating pattern being too cold, thereby preventing piglets from receiving efficient heating, and the center of the heating pattern being too warm, potentially subjecting piglets to overheating and burns. Heat lamps therefore generate a net usable area between the center and outer boundary of the heating pattern, which may account for only twenty percent of the entire isotropic heating pattern, which, when combined with energy loss of the heat lamp, can translate into a heating efficiently of five percent or less as measured by received energy. Moreover, any unused heat converts into waste heat that may need to be vented from the farrowing area to prevent nearby sows from overheating.

Heat lamps may also present a high risk of fire. For example, heating lamps typically utilize halogen or other heating elements that reach very high temperatures during operation. Such temperatures may cause nearby objects to inadvertently catch fire if placed too close to the heating element. Many livestock operations operate under an extreme risk of fire due to the high flammability of bedding, feed, dust, and animals themselves. Fire can spread through livestock housing in a matter of minutes. Worse yet, fires quickly spread from one livestock house to others, resulting in extreme losses.

Some livestock heating systems may utilize heating mats to generate heat. However, heating mats also distribute heat unevenly. Heat mats are typically constructed of a plastic material into which is embedded a resistive element, such as a wire. When a current is applied across the wire, heat emanates from the wire, creating hotter areas on the heat mat near the embedded wire and cooler areas on the heat mat further away from the embedded wire. Another drawback associated with heat mats is their tendency to overheat and burn the piglets if the heat mats are not attached to a thermostat. Even if a heat mat is attached to a thermostat, due to its uneven heating, the heat mat may still burn the piglets if the thermostat is positioned on a cooler portion of the heat mat. Alternatively, the heat mat may insufficiently heat the piglets if the thermostat is positioned on a warmer area of the heat mat near an embedded wire.

Although heating mats generally operate at lower temperatures than heat lamps, heating mats are still susceptible to catching fire if damaged. For example, when heating mats are used in livestock operations, livestock may apply very large amounts of downward pressure when standing and/or laying on such heating mats. In such applications, heating elements in conventional heating mats may become damaged when such weight is repeatedly applied to the heating mats. Damage to heating elements may cause shorts resulting in fires or hot spots that can harm livestock.

Therefore, for all the reasons stated above, and the reasons stated below, there is a need in the art for a livestock heating system that improves upon the state of the art. Thus, it is a primary object of the disclosure to provide a heating mat system that improves upon the state of the art.

Another object of the disclosure is to provide a heating mat system that is safe to use.

Yet another object of the disclosure is to provide a heating mat system that is less susceptible to damage.

Another object of the disclosure is to provide a heating mat system that provides more uniform heat distribution.

Yet another object of the disclosure is to provide a heating mat system that is configured for use in livestock operations.

Another object of the disclosure is to provide a heating mat system that is easy to deploy.

Yet another object of the disclosure is to provide a heating mat system that is easy to install.

Another object of the disclosure is to provide a heating mat system that has a long useful life.

Yet another object of the disclosure is to provide a heating mat system that is durable.

Another object of the disclosure is to provide a heating mat system that has a robust design.

Yet another object of the disclosure is to provide a heating mat system that is self-healing.

Another object of the disclosure is to provide a heating mat system that is easy to use.

Yet another object of the disclosure is to provide a heating mat system that is high quality.

These and other objects, features, or advantages of the disclosure will become apparent from the specification, figures and claims.

### SUMMARY OF THE DISCLOSURE

In one or more arrangements, a heating mat system is provided having a heating layer positioned between an upper support pad and a lower support pad. The heating layer including a conductive microfilm. The conductive microfilm having a generally planar shape extending between a front edge, a rear edge, and opposing side edges. The conductive microfilm includes a layer of graphene. A first electrical contact and a second electrical contact are connected to the conductive microfilm. Application of a voltage difference between the first electrical contact and the second electrical contact causes current to flow through the conductive microfilm, thereby generating heat.

In one or more arrangements, the conductive microfilm includes a plurality of layers of graphene. In one or more arrangements, the conductive microfilm includes a stack of eight layers of graphene. In one or more arrangements, the conductive microfilm includes a layer of nano-carbon fiber material. In one or more arrangements, the conductive microfilm has a non-continuous pattern. In one or more arrangements, the conductive microfilm has a honey-comb pattern. In one or more arrangements, the conductive microfilm is self-healing. In one or more arrangements, the layer of graphene distributes heat to portions of the layer of graphene where less current flows to provide even heat distribution.

In one or more arrangements, the heating layer includes an upper substrate layer and a lower substrate layer and the conductive microfilm is positioned between the upper substrate layer and the lower substrate layer. In one or more arrangements, the upper substrate layer and the lower substrate layer are a plastic film.

In one or more arrangements, wherein the lower support pad includes an insulated portion. In one or more arrangements, the lower support pad includes a heat reflector. In one or more arrangements, the current that flows through the conductive microfilm causes the conductive microfilm to emit infrared radiation and the upper support pad includes a material configured to absorb infrared radiation.

In one or more arrangements, an upper surface of the upper support pad has a grip pad. In one or more arrangements, a lower surface of the lower support pad has a grip pad. In one or more arrangements, the upper support pad has a textured upper surface. In one or more arrangements, the lower support pad has a textured lower surface.

### BRIEF DESCRIPTION OF THE DRAWINGS

FIG. 1 shows a top perspective view of the heating mat system, in accordance with one or more embodiments, the view showing the heating mat system having an upper support pad, a lower support pad, and a heating layer.

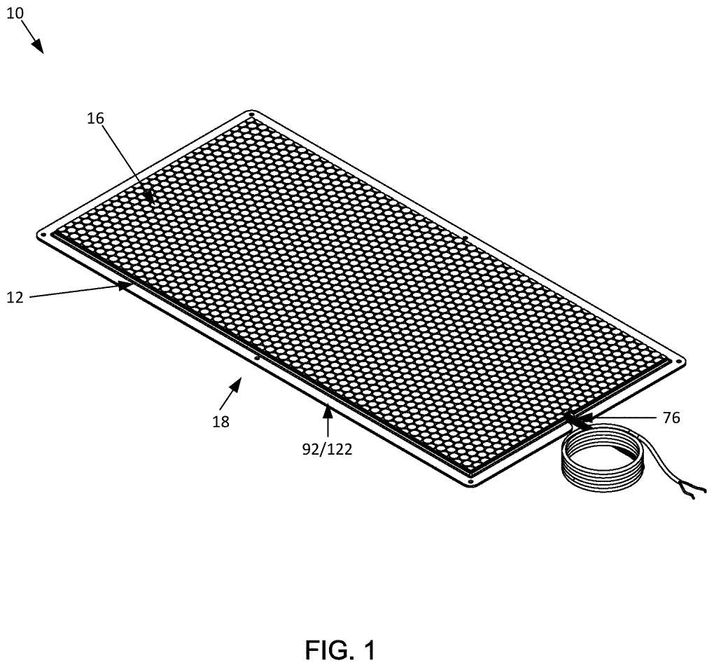

FIG. 2 shows a top perspective view of the heating system, in accordance with one or more embodiments, the view showing the heating mat system having an upper support pad, a lower support pad, and a heating layer.

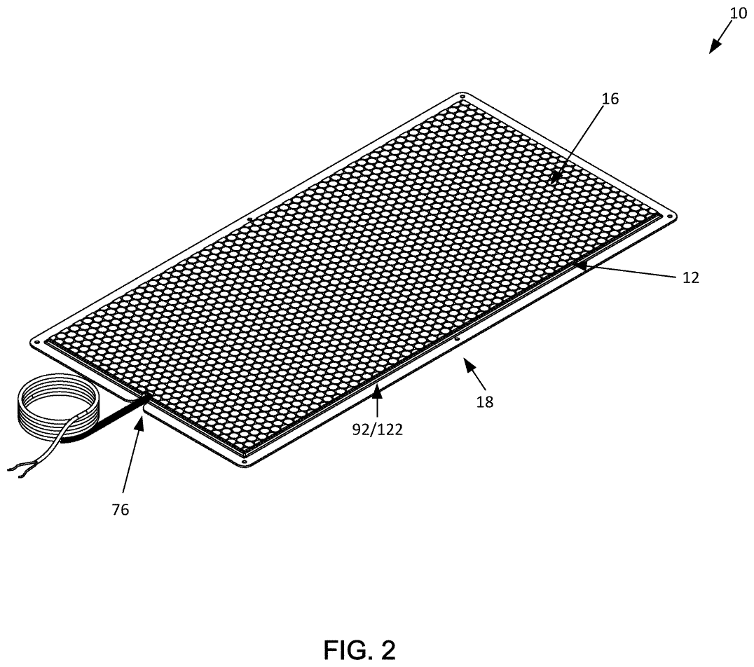

FIG. 3 shows a top elevation view of the heating mat system, in accordance with one or more embodiments, the view showing the heating mat system having a lower support pad with a flange and an upper support pad with a flange; the view also showing the heating mat system having grip pads.

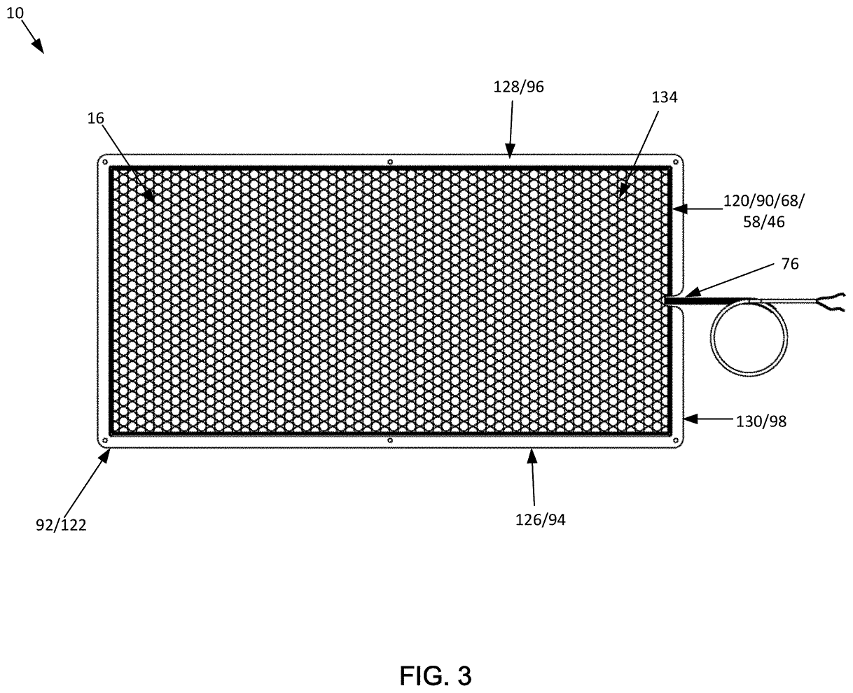

FIG. 4 shows a bottom elevation view of the heating mat system, in accordance with one or more embodiments, the view showing the heating mat system having a lower support pad.

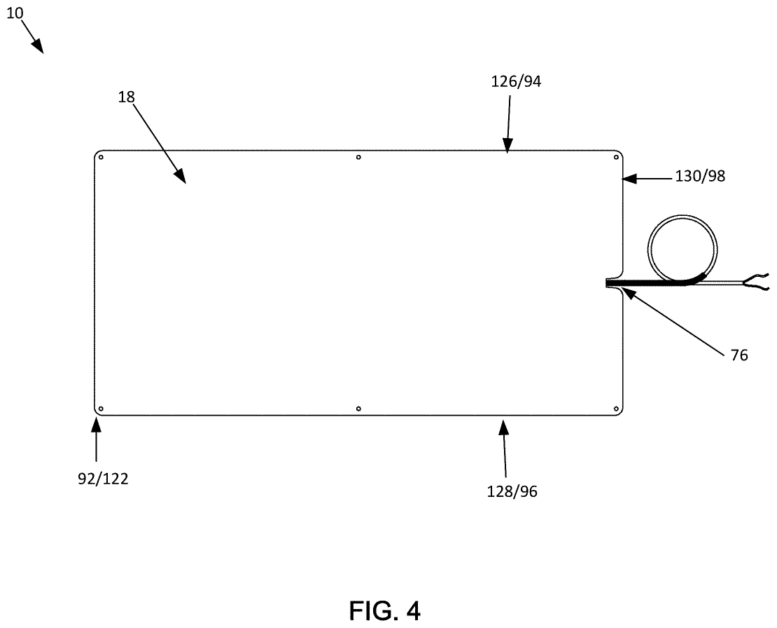

FIG. 5 shows a side elevation view of the heating mat system, in accordance with one or more embodiments, the view showing the heating mat system having an upper support pad, a lower support pad, and a heating layer. The view also showing the upper support pad having a flange and the lower support pad having a flange.

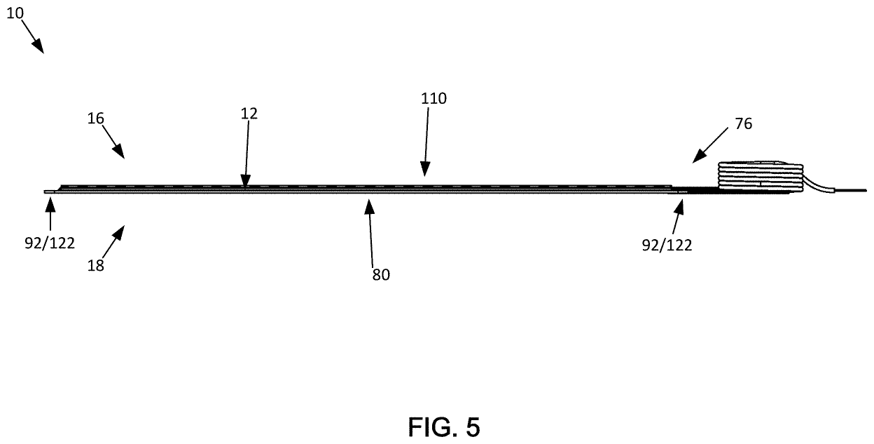

FIG. 6 shows a side elevation view of the heating mat system, in accordance with one or more embodiments, the view showing the heating mat system having an upper support pad, a lower support pad, and a heating layer. The view also showing the upper support pad having a flange and the lower support pad having a flange.

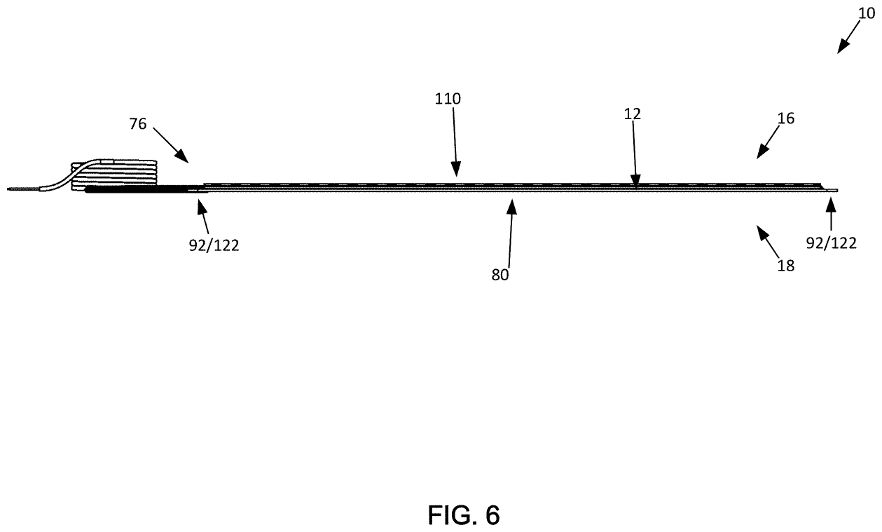

FIG. 7 shows a close up side elevation view of the connection point of the heating mat system, in accordance with one or more embodiments, the view showing the heating mat system having an upper support pad, a lower support pad, and a heating layer. The view also showing the upper support pad having a flange and the lower support pad having a flange.

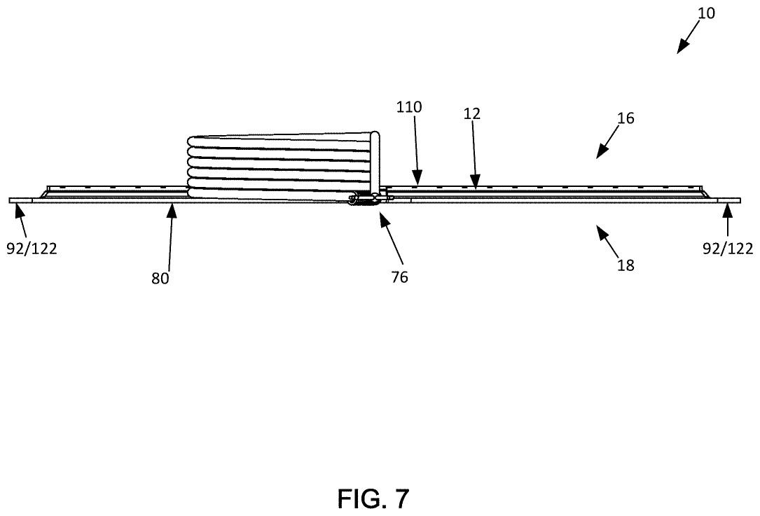

FIG. 8 shows a close up side elevation view of the heating mat system, in accordance with one or more embodiments, the view showing the heating mat system having an upper support pad and a lower support pad. The view also showing the upper support pad having a flange and the lower support pad having a flange.

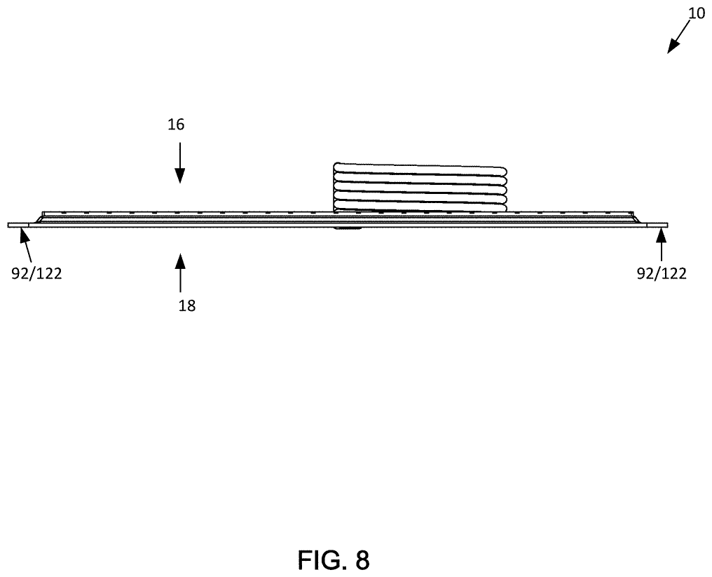

FIG. 9 shows a cross section side view of the heating mat system, in accordance with one or more embodiments, the view showing components of the upper support pad, lower support pad, and the heating layer; the view also showing the heating layer having a conductive microfilm, an upper substrate layer, and a lower substrate layer. The view also showing the lower support pad having a flange and the upper support pad having a flange.

FIG. 10 shows a top elevation view of the heating mat system, in accordance with one or more embodiments, the view showing cross sections of the upper support pad, upper substrate layer, conductive microfilm, lower substrate layer, and lower support pad; the view also showing the heating mat system having conductive traces.

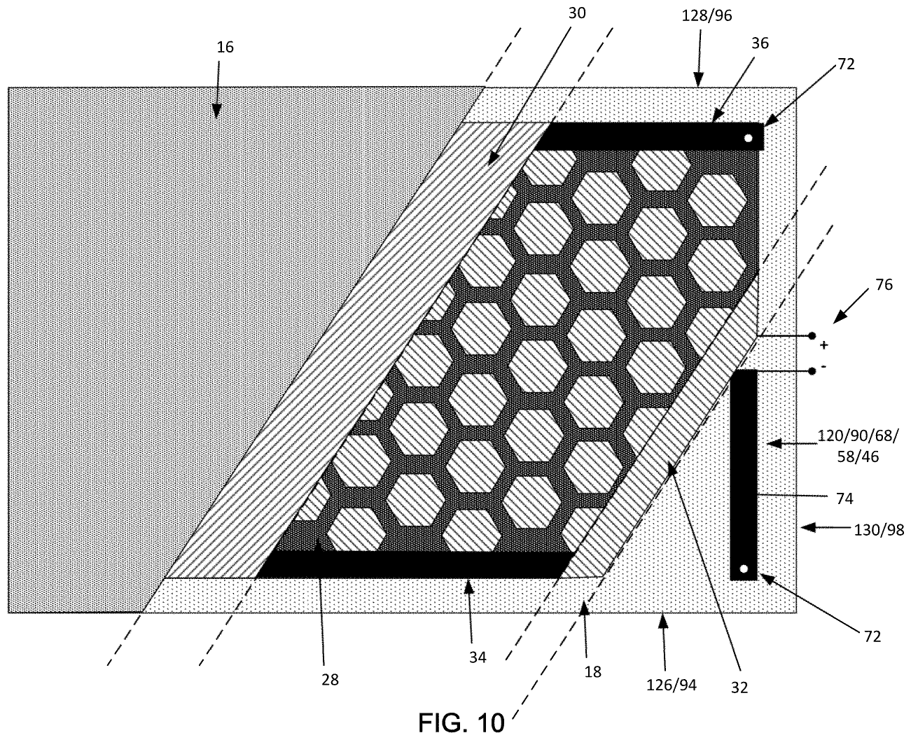

FIG. 11 shows a top elevation view of the heating mat system, in accordance with one or more embodiments, the view showing cross sections of the conductive microfilm, lower substrate layer, and lower support pad; the view also showing the heating mat system having a connection point.

FIG. 12 shows an alternative top elevation view of the heating mat system, in accordance with one or more embodiments, the view showing cross sections of the conductive microfilm, lower substrate layer, and lower support pad; the view also showing the heating mat system having a connection point.

FIG. 13 shows an elevation view of the heating mat system, in accordance with one or more embodiments, the view showing the heating mat system having an upper substrate layer, conductive microfilm, and a lower substrate layer.

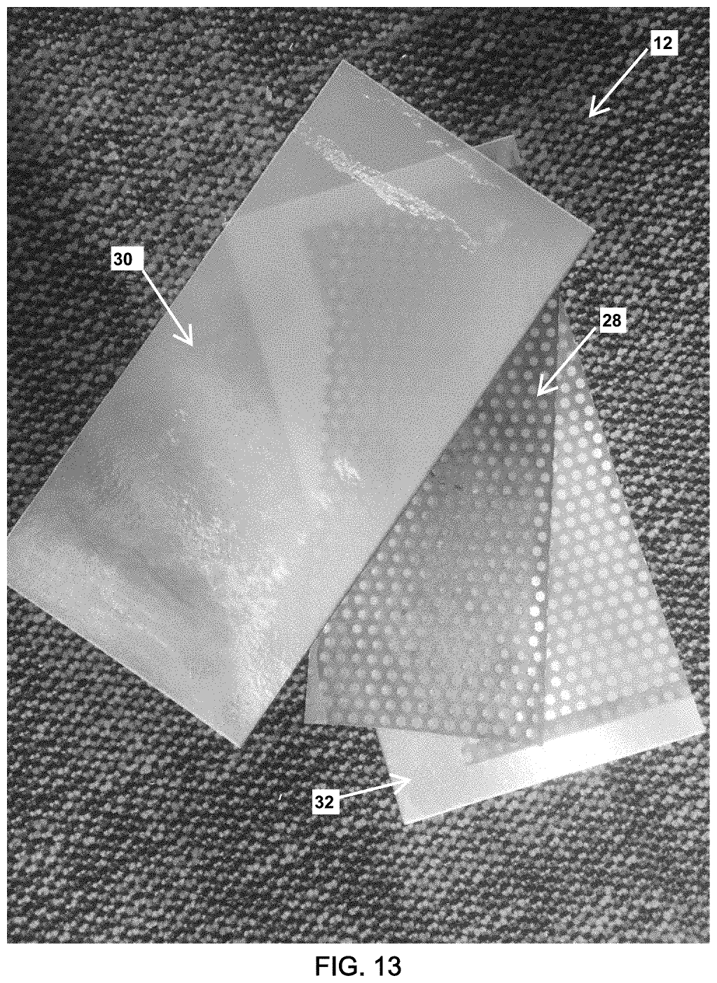

FIG. 14 shows an elevation view of the heating mat system, in accordance with one or more embodiments, the view showing the heating mat system having an upper substrate layer, conductive microfilm, and a lower substrate layer.

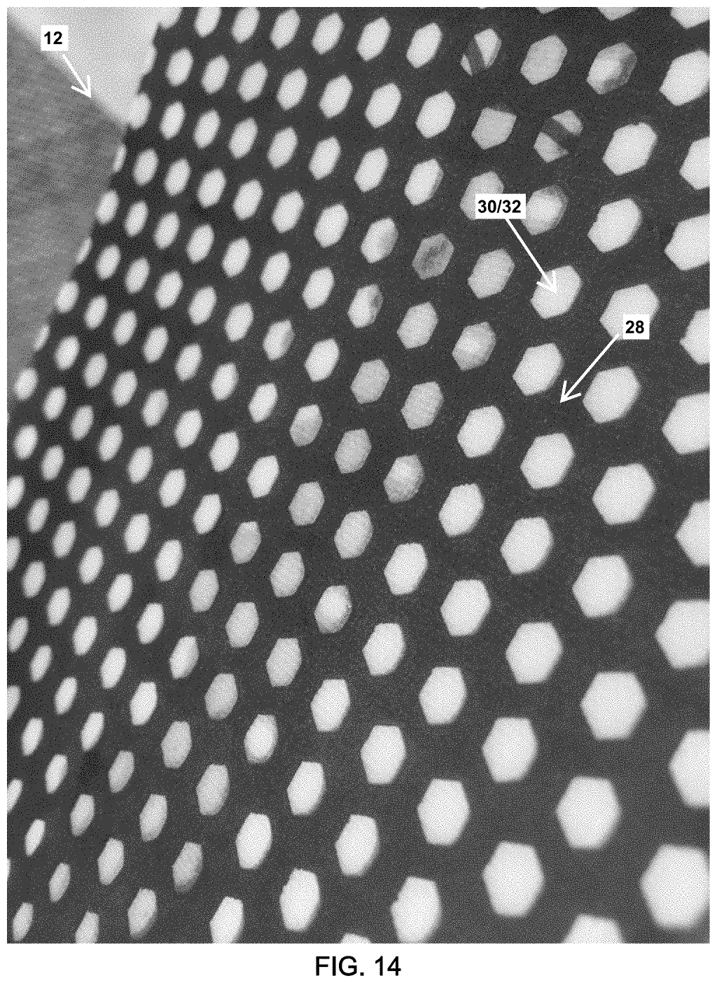

FIG. 15 shows a close up elevation view of the heating mat system, in accordance with one or more embodiments, the view showing the heating mat system having an upper substrate layer, conductive microfilm, and a lower substrate layer.

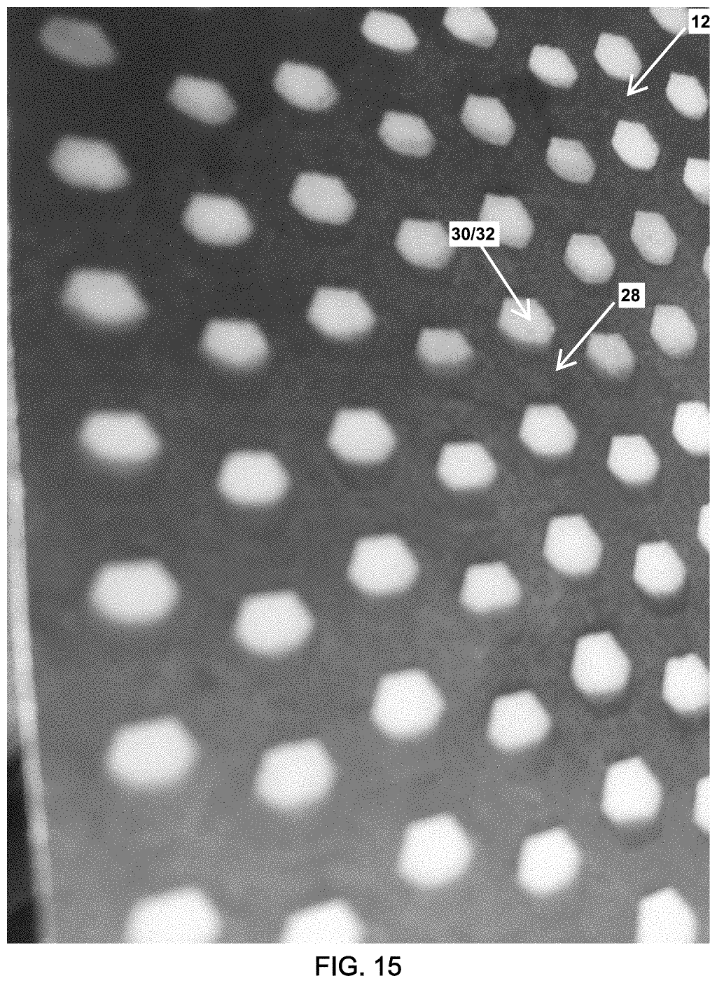

FIG. 16 shows an elevation view of the heating mat system, in accordance with one or more embodiments, the view showing one embodiment of the heating mat system.

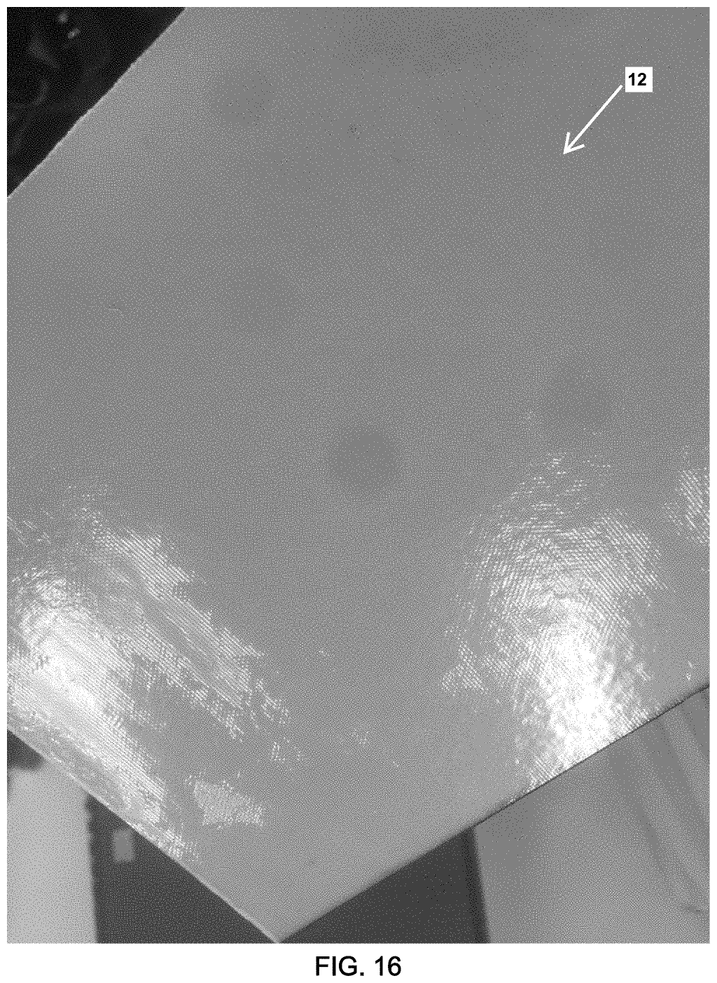

FIG. 17 shows a close up view of the heating mat system, in accordance with one or more embodiments, the view showing the heating mat system having an upper substrate layer, a lower substrate layer, conductive microfilm, and electric contacts.

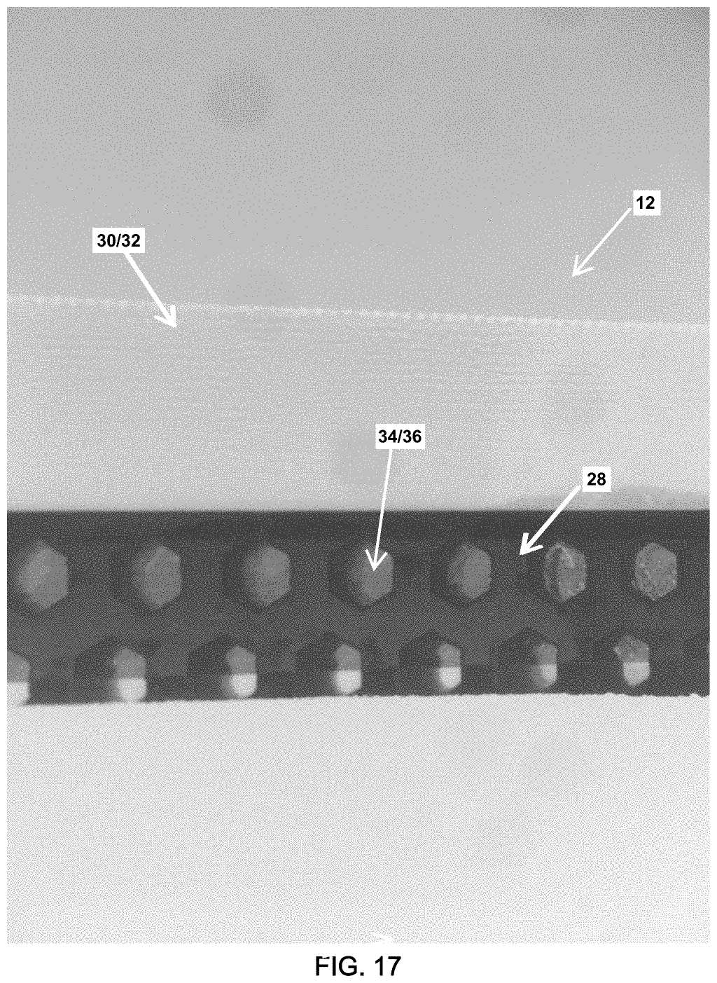

FIG. 18 shows a close up view of the heating mat system, in accordance with one or more embodiments, the view showing the heating mat system having an upper substrate layer, a lower substrate layer, and electric contacts.

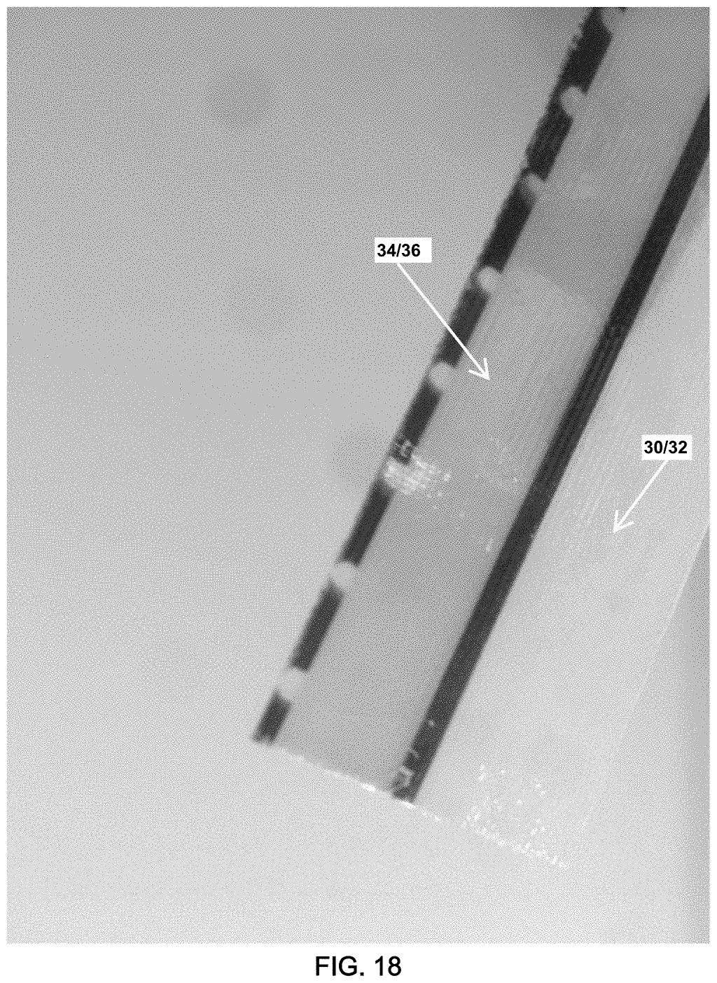

FIG. 19 shows a close up view of the heating mat system, in accordance with one or more embodiments, the view showing the heating mat system having an upper support pad with a flange, a lower support pad with a flange, sidewalls, and insulative air pockets.

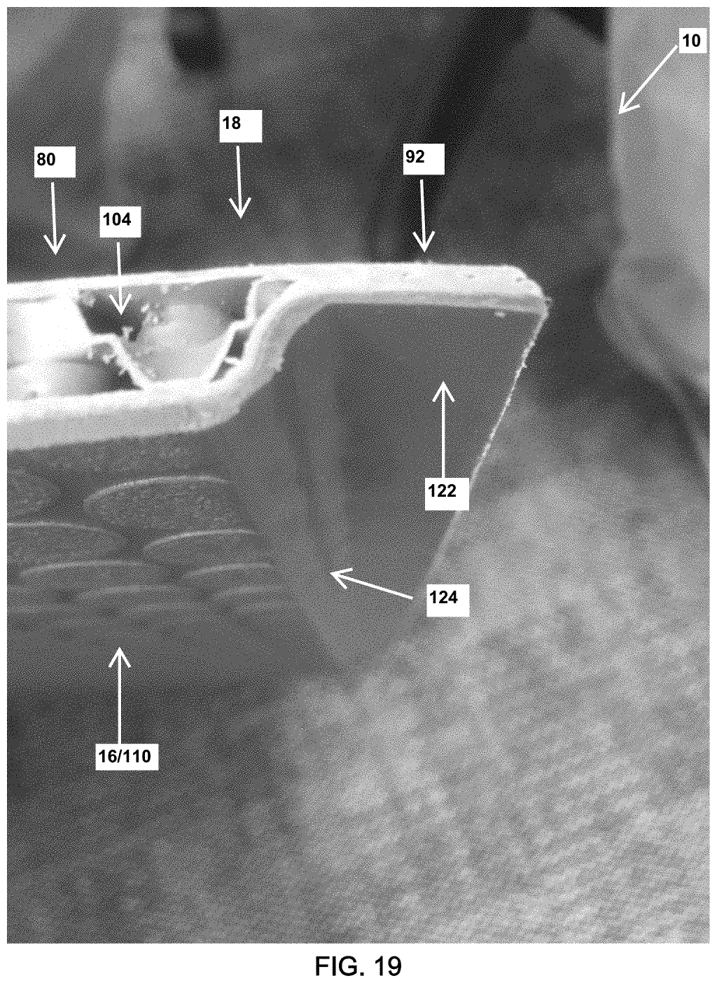

FIG. 20 shows a cross section view of the heating mat system, in accordance with one or more embodiments, the view showing the heating mat system having an upper support pad, a lower support pad, a heating layer, and insulative air pockets

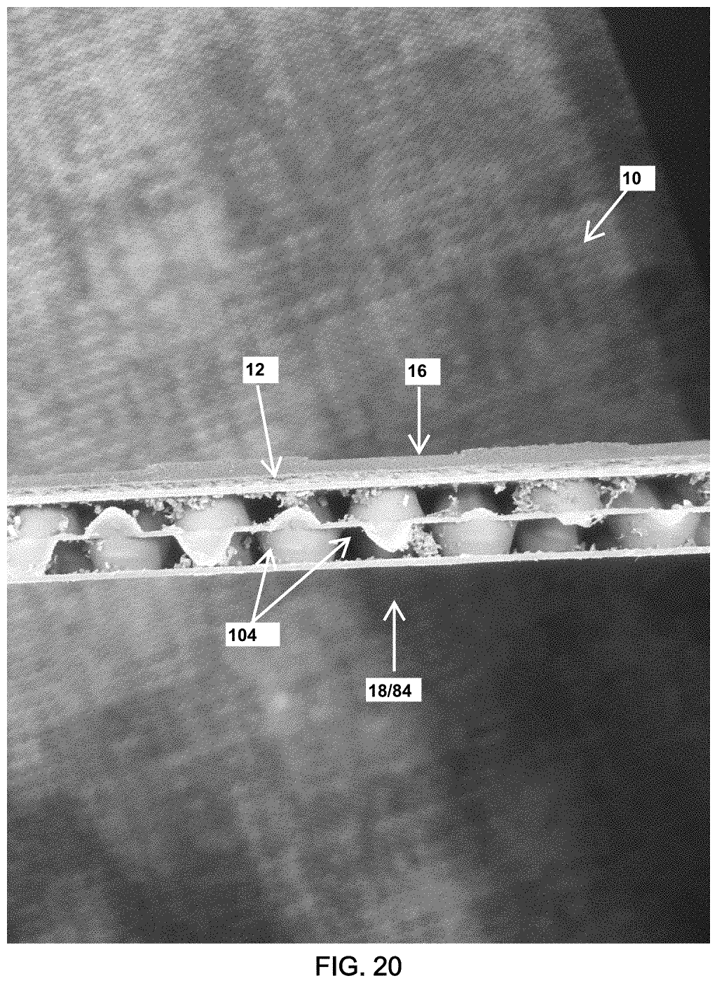

FIG. 21 shows a cross section view of the heating mat system, in accordance with one or more embodiments, the view showing the heating mat system having an upper support pad, a lower support pad, a heating layer, and insulative air pockets.

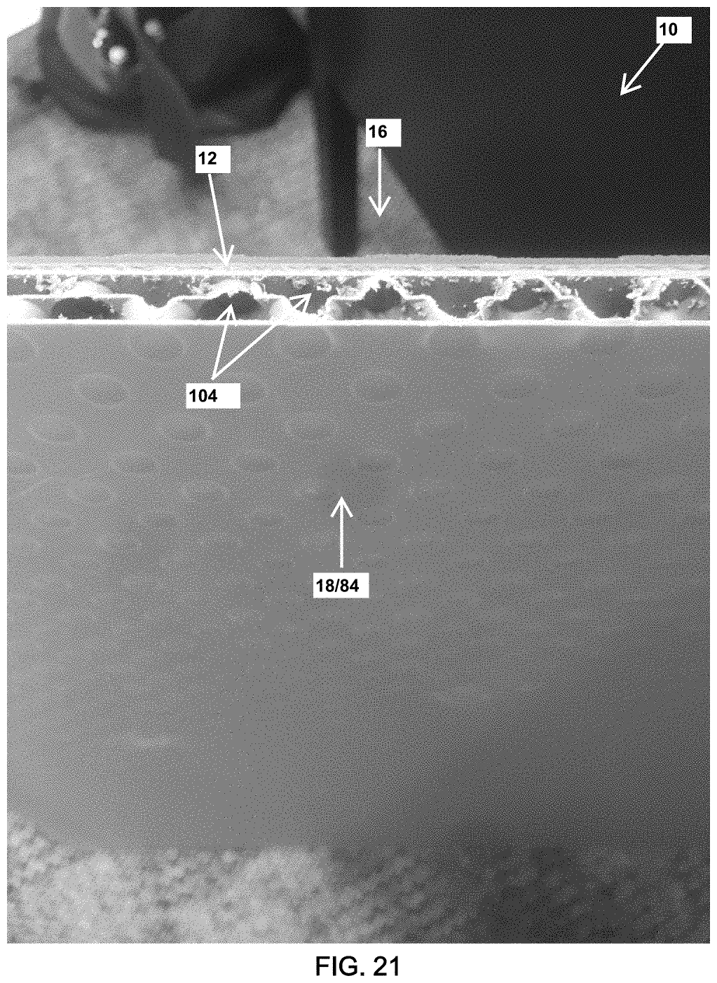

FIG. 22 shows a top view of the heating mat system, in accordance with one or more embodiments, the view showing the heating mat system having grip pads on the upper support pad of the heating mat system.

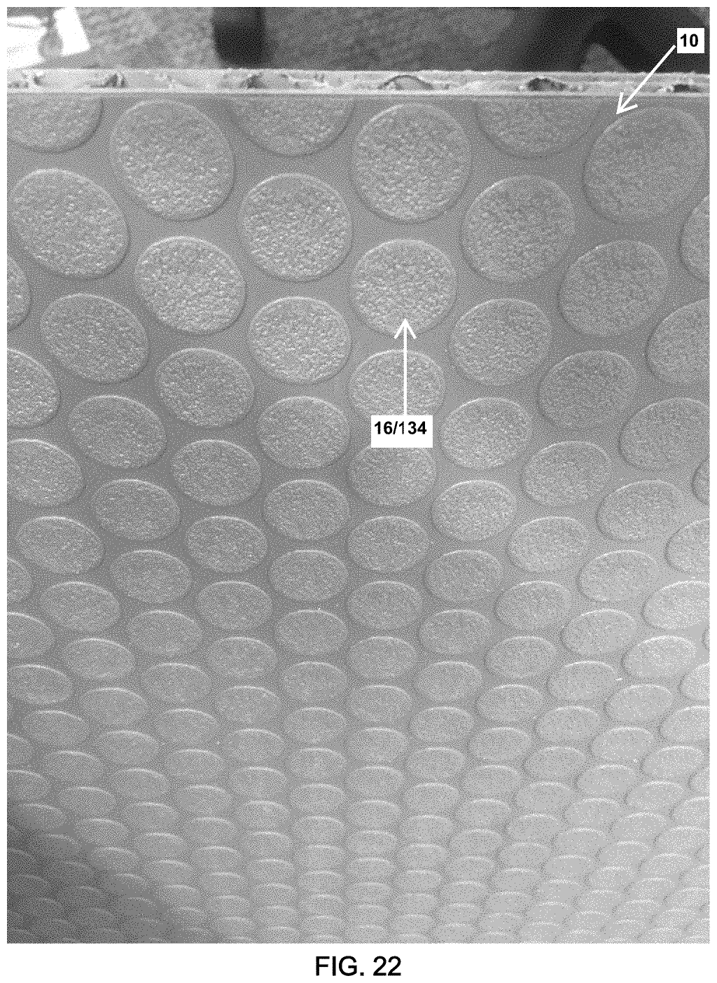

FIG. 23 shows a top view of the heating mat system, in accordance with one or more embodiments, the view showing the heating mat system having grip pads on the upper support pad of the heating mat system; the view also showing the heating mat system having a connection point.

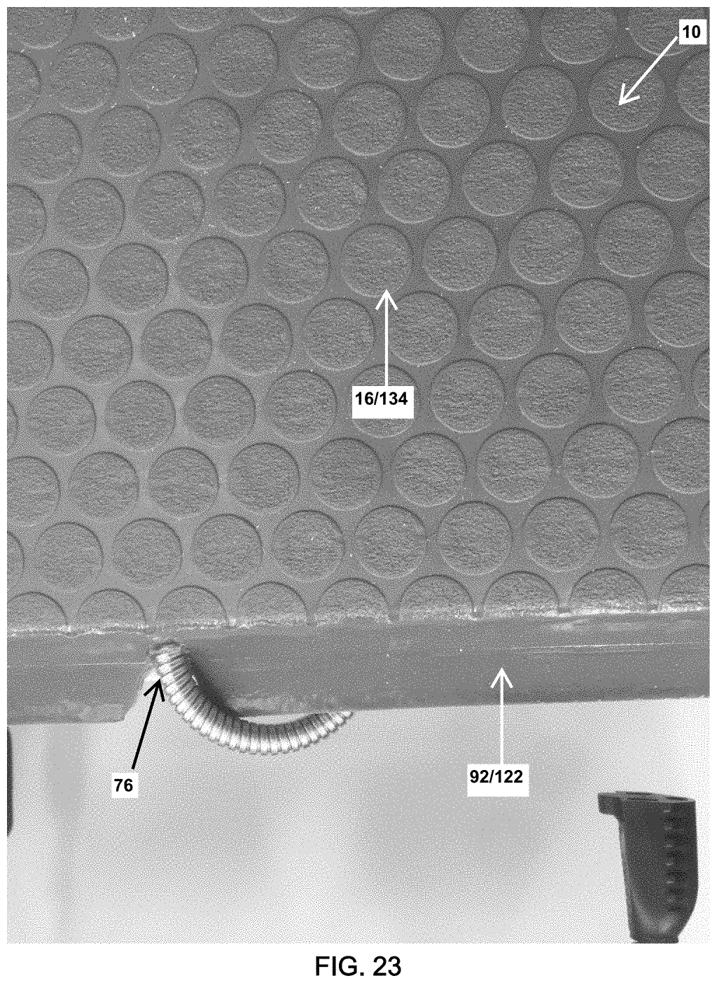

FIG. 24 shows a close up view of the heating mat system, in accordance with one or more embodiments, the view showing the heating mat system having a flange of an upper support pad and a flange of a lower support pad.

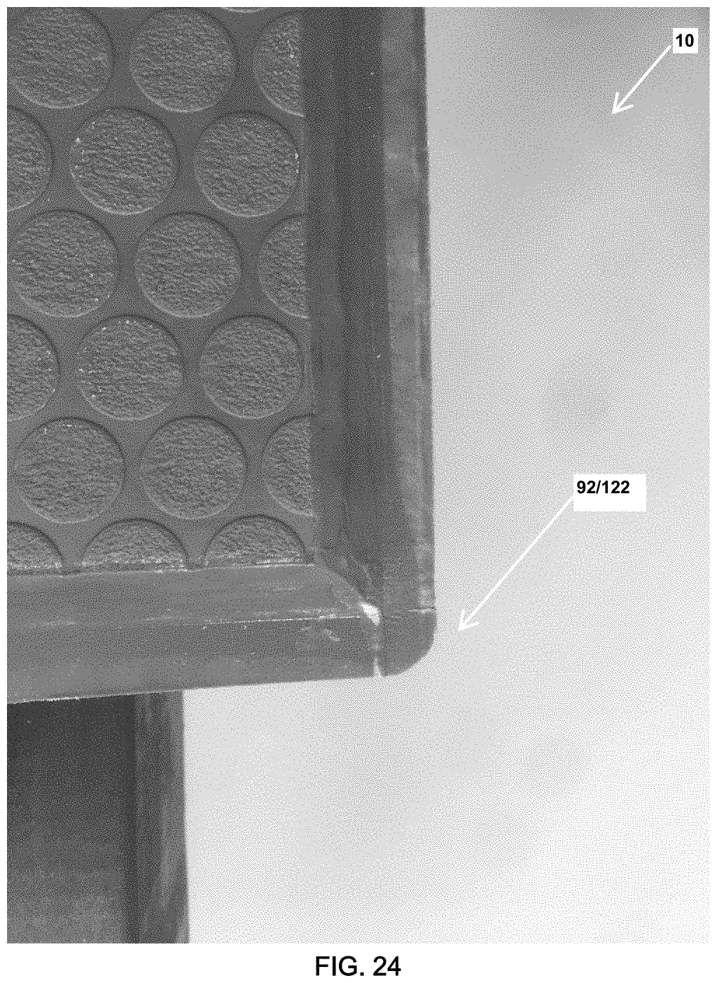

FIG. 25 shows an example control system for use in a heating mat system for use with livestock, in accordance with one or more embodiments.

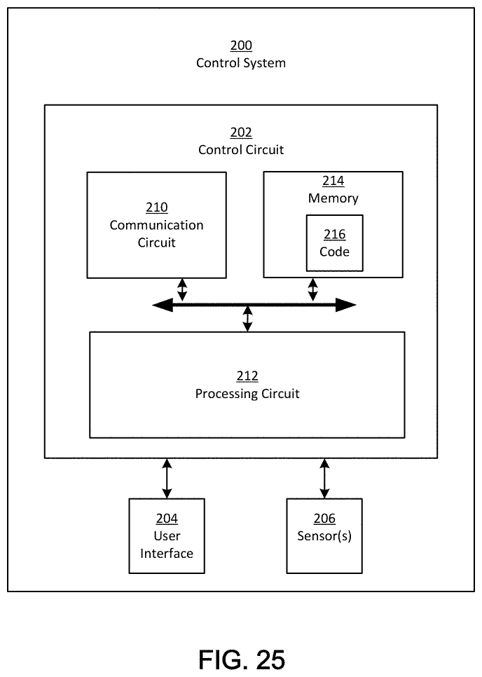

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of farming, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of heating mats for livestock. However, the embodiments are not so limited. It is appreciated that the embodiments may be adapted for use in various other applications, which may be improved by the disclosed structures, arrangements and/or methods. The system is merely shown and described as being used in the context of heating mats for livestock for ease of description and as one of countless examples.

### System 10:

In various embodiments, a heating mat system 10 (or simply system 10) may be formed of any suitable size, shape, and design and is configured to function as a mat that is heated when operated to facilitate, for example, care of livestock, such as for warming pigs or piglets. In the arrangement shown, as one example, system 10 includes a heating layer 12 positioned between an upper support pad 16 and a lower support pad 18, among other components.

### Heating Layer 12:

Heating layer 12 is formed of any suitable size, shape, and design and is configured to generate heat across heating mat system 10. In the arrangement shown, as one example, heating layer 12 includes a conductive microfilm 28, one or more substrate layers 30/32, and a set of electrical contacts 34/36 electrically connected to the conductive microfilm 28. During operation, electric potential difference is applied between the electrical contacts 34/36 which causes current to flow across the conductive microfilm 28 which in turn generates heat.

### Conductive Microfilm 28:

Conductive microfilm 28 is formed of any suitable size, shape, and design and is configured to provide a conductive pathway that extends along heating layer 12 between electrical contacts 34/36 and that generates heat in response to electric current moving along the conductive pathway. In the arrangement shown, as one example, conductive microfilm 28 has a generally planar rectangular shape having an upper surface 38 and lower surface 40 extending between a front edge 42, a rear edge 44, and opposing side edges 46.

In one or more arrangements, conductive microfilm 28 is formed by a layer of graphene and/or a plurality of layers of graphene. Graphene is an allotrope of carbon consisting of a single layer of atoms arranged in a two-dimensional honeycomb lattice nanostructure. Graphene generates thermal and infrared heat when current is applied to it. However, graphene has not been a material of choice for larger applications (e.g., heating mats) due to the cost and complexity of graphene manufacture. For example, it can be difficult to form graphene at larger scales without defects. However, through careful observation and experimentation, it has been surprisingly discovered that graphene layers operate very well as a heating element even when defects are created in manufacture and/or use due to the high thermal conductivity of graphene. For example, if defects (e.g., cracks) appear in a graphene layer during manufacture or use, conductive microfilm 28 is able to route current around the defects to continue operation of system 10. In this manner, the conductive microfilm 28 is self-healing. While routing of current around defects may cause more electric current to flow through certain portions of conductive microfilm 28, the high thermal conductivity of graphene is able to distribute heat away from those portions to portions where less electric current has flowed to provide relatively even heat distribution even when electrical connectivity is not evenly distributed. The graphene and some other nano-carbon fiber materials are also self-healing at a molecular level. For example, experimentation has shown that graphene has a tendency of reconnecting bonds between carbon atoms that are separated by small distances (e.g., 0.3-0.5 nm).

Although some arrangements may be primarily discussed with reference to heating layer 12 having conductive microfilm 28 formed by a layer of graphene, the embodiments are not so limited. Rather, it is contemplated that in some various arrangements, conductive microfilm 28 may be formed of various conductive materials including but not limited to: graphene, nano-carbon fiber materials, metallic materials such as copper, silver, gold, aluminum, tungsten, and/or other metallic materials, and/or a combination of various materials such as a carbon silver nanomaterial mixture. In the arrangement shown, conductive microfilm 28 is formed by a single layer of graphene. However, the embodiments are not so limited. Rather, it is contemplated that in one or more arrangements, conductive microfilm 28 may include multiple layers of graphene or other material(s) that are spaced apart, layered adjacent to one another, and/or connected together. In addition, a single layer of graphene may have a single molecular layer of graphene or multiple molecular layers of graphene. The graphene may be formed in a single sheet of material containing graphene. Alternatively, the graphene may be formed in multiple sheets of material each containing graphene that are then laid on top of one another and/or laminated on top of one another.

Notably, the layers of graphene or sheets of graphene may be protected by a protective coating such as being impregnated with a plastic or other material or by being laminated between sheets of plastic, or by being coated or covered or impregnated or doped by any other material that increases its strength and durability and longevity.

The use of multiple layers of graphene in conductive microfilm 28 increases the cumulative temperature generated by the conductive microfilm 28 during operation. For example, in one or more arrangements, conductive microfilm 28 includes eight (8) layers of graphene that are sandwiched together and reaches approximately 260 degrees Fahrenheit during operation, with each added layer of graphene providing approximately a 30 degree Fahrenheit increase in temperature. Any other number of layers is hereby contemplated such as 1, 2, 3, 4, 5, 6, 7, 8, 9, 10, 20, 30, 40, 50, 100 or more or any number therein.

In one or more arrangements, conductive microfilm 28 is distributed along heating layer 12 in a non-continuous pattern. In the arrangement shown, as one example, conductive microfilm 28 has graphene extending along a honeycomb pattern. However, the embodiments are not so limited and any other pattern is hereby contemplated for use. Rather it is contemplated that in some various different arrangements, conductive microfilm 28 may extend in a continuous manner or non-continuous manner including but not limited to for example, an arrangement of triangles, squares, pentagons, hexagons (e.g., honeycomb shaped), stripes, zig-zags, and/or any other discontinuous shape or pattern.

### Substrate Layer(s) 30/32:

Substrate layer(s) 30/32 are formed of any suitable size, shape, and design and are configured to operably connect with and support conductive microfilm 28 and/or electrical contacts 34/36. In the arrangement shown, as one example, heating layer 12 includes an upper substrate layer 30 attached to upper surface 38 of conductive microfilm 28 and a lower substrate layer 32 attached to lower surface 40 of conductive microfilm 28. However, the embodiments are not so limited. For example, in one or more arrangements, heating layer 12 has conductive microfilm 28 supported by a single substrate layer 30.

In the arrangement shown, substrate layers 30/32 have a similar shape to conductive microfilm 28. In this example arrangement, upper substrate layer 30 has a generally planar rectangular shape having an upper surface 50 and a lower surface 52 extending between a front edge 54, rear edge 56, and opposing side edges 58, which are generally aligned with front edge 42, rear edge 44, and opposing side edges 46 of conductive microfilm 28, respectively, in this example, or extending slightly past the edge of the conductive microfilm 28. Similarly, in this example arrangement, lower substrate layer 32 has a generally planar rectangular shape having an upper surface 60 and a lower surface 62 extending between a front edge 64, rear edge 66, and opposing side edges 68, which are generally aligned with front edge 42, rear edge 44, and opposing side edges 46 of conductive microfilm 28, respectively, in this example or extending slightly past the edge of the conductive microfilm 28.

Substrate layer(s) 30/32 may be formed of various materials configured to support and prevent damage to conductive microfilm 28 during operation. In one or more arrangements, as one example, substrate layer(s) 30/32 are formed of a fiberglass resin backing. However, the embodiments are not so limited. Rather, it is contemplated that in some various arrangements, substrate layer(s) 30/32 may be formed of various materials including but not limited to, for example, polymers, resins, textiles, composites, and/or any other natural or synthetic materials.

In some arrangements, conductive microfilm 28 is formed on one of substrate layers 30/32, for example by depositing graphene or other conductive material 28 on the substrate layer 30/32. In some other arrangements, conductive microfilm 28 may be formed and then transferred and affixed to one or both of substrate layers 30/32. For example, in one or more arrangements, a substrate layer 30/32 may be coated with an adhesive and used to lift conductive microfilm 28 off of a surface on which it was formed.

### Electrical Contacts 34/36:

Electrical contacts 34/36 are formed of any suitable size, shape, and design and are configured to facilitate application of an electric potential difference across conductive microfilm 28 and thereby induce flow of current across conductive microfilm 28 and cause conductive microfilm 28 to generate heat. In one arrangement shown, as one example, electrical contacts 34/36 each extend along opposing front and rear edges 42/44 of conductive microfilm 28 between opposing side edges 46. In this example arrangement, electrical contacts 34/36 are connected by a via 72 that extends through one of the substrate layers 30/32 to one or more conductive traces 74 positioned on the other side of the substrate layer 30/32. The conductive traces 74 extend inward along one of the side edges 46 to a connection point 76. In this example arrangement, a first electric contact 34 extends along and is electrically connected to front edge 42 of conductive microfilm 28 and a second electric contact 36 extends along and is electrically connected to rear edge 44 of conductive microfilm 28. In this example arrangement, when an electric potential difference is applied to the first and second electric contacts 34/36, the electric potential difference is provided to the front edge 42 and rear edge 44 of conductive microfilm 28, which causes current to flow from a negatively charged one of the first and second electric contacts 34/36, through conductive microfilm 28, to a positively charged one of the first and second electric contacts 34/36.

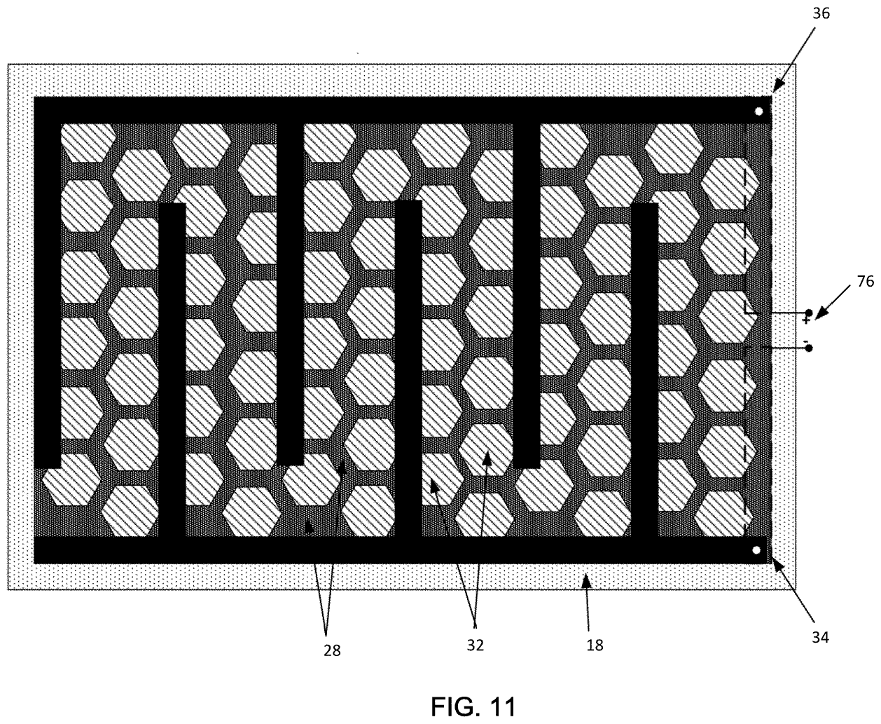

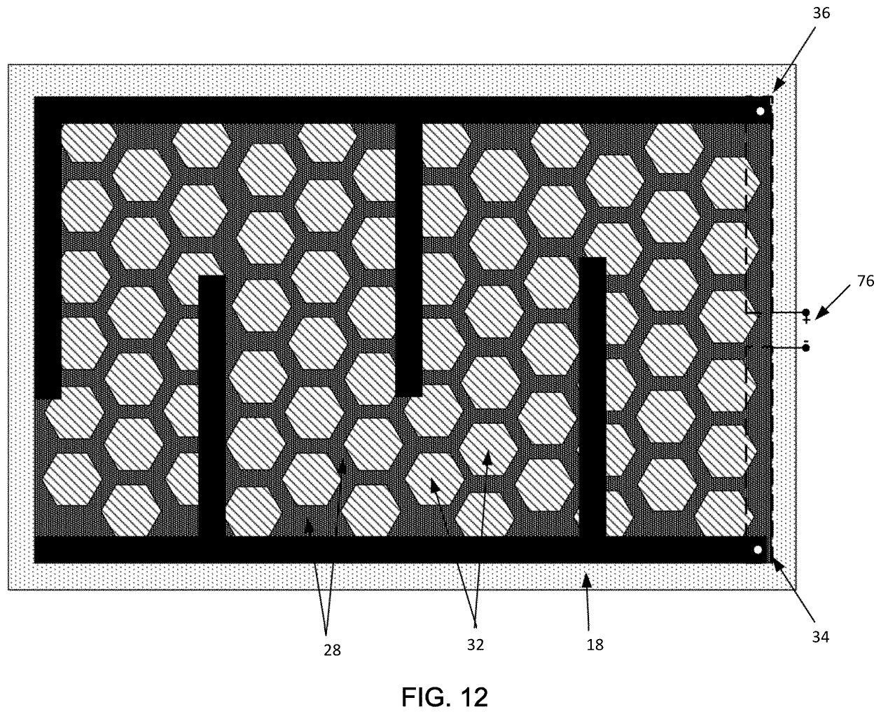

However, the embodiments are not so limited. Rather, it is contemplated that in some various arrangements, electrical contacts 34/36 may have various different shapes configured to apply voltage potentials to various portions of conductive microfilm 28. For example, in one or more arrangements, electrical contacts 34/36 may have comb shapes positioned with teeth interleaved to increase the surface area at which electrical contacts 34/36 electrically connect with conducive microfilm 28 as shown in FIGS. 11 and 12. It is contemplated, that electrical contacts 34/36 may additionally or alternatively have any other shape or configuration suitable for distributing power across conductive microfilm 28.

### Upper Support Pad 16 and Lower Support Pad 18:

Upper support pad 16 and lower support pad 18 are formed of any suitable size, shape, and design and are configured to encase heating layer 12 and form a mat on which livestock, such as piglets, or various objects may be heated during operation.

### Lower Support Pad 18:

In this example arrangement, lower support pad 18 has a generally planar rectangular shaped main body 80 having an upper surface 82 and a lower surface 84 extending between a front edge 86, a rear edge 88, and opposing side edges 90. In this example arrangement, front edge 86, rear edge 88, and side edges 90 are generally aligned with edges 42, 44, and 46 of conductive microfilm 28, respectively, or extending slightly past the edge of the conductive microfilm 28. In this example arrangement, lower support pad 18 includes a flange 92 that extends outward from a lower end of edges 86, 88, and 90 of main body 80 to an outer front edge 94, an outer rear edge 96, and outer side edges 98. Flange 92 extends outward beyond edges 42, 44, and 46 of conductive microfilm 28 to facilitate connection with upper support pad 16 and/or connection of system 10 to a floor.

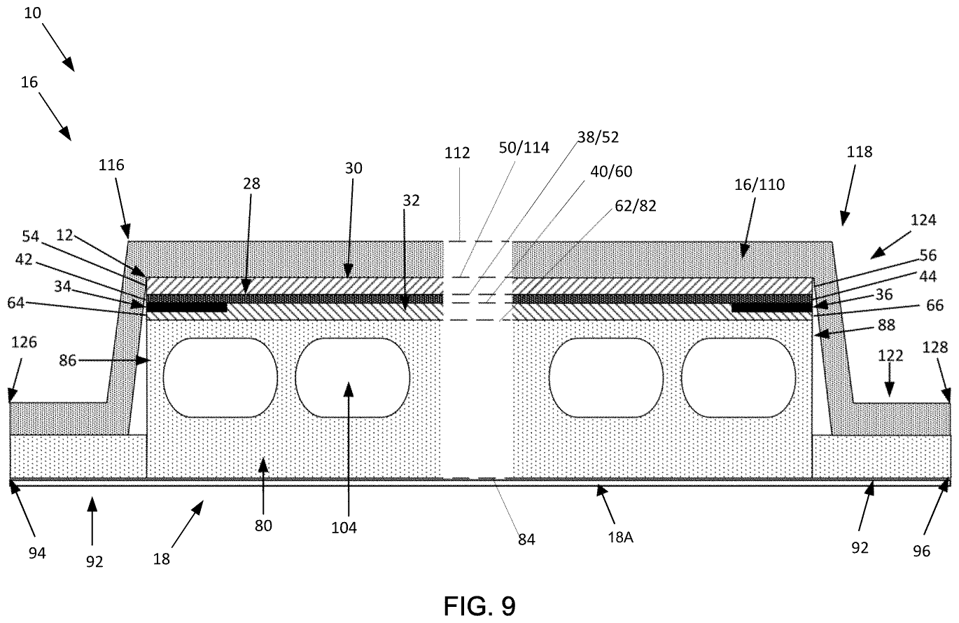

In one arrangement, lower support pad 18 is formed of or includes a layer 18A of Boltaron® or another similar material that provides substantial fire resistance characteristics as well as strength, ruggedness and durability. In one arrangement this layer is formed of Boltaron® 4330. This layer is shown in FIG. 9 as reference numeral 18A. Boltaron® is an extremely durable acrylic PVC alloy that also provides substantial fire resistance characteristics. In one arrangement, the lawyer of this material 18A is approximate 60 thousandths of an inch thick. This layer 18A may be adhered directly to the bottom side of lower support pad 18 or replace it altogether.

### Insulation/Heat Reflection:

In one or more arrangements, lower support pad 18 or a portion thereof may be insulated to reduce the transfer of heat to the floor/ground. In the arrangement shown, as one example, main body 80 of lower support pad 18 includes a honeycomb or other inner structure having a plurality of insulative air-pockets 104. However, the embodiments are not so limited. Rather, it is contemplated that in some various arrangements, lower support pad 18 may incorporate various methods and/or means for insulation including but not limited to, air pockets, fiberglass, foam, cellulose, mineral wool, reflective and/or radiant barriers, and/or any other method and/or means for insulating.

Additionally or alternatively, in one or more arrangements, lower support pad 18 or a portion thereof may include a heat reflector (not shown) to reduce the transfer of heat to the floor/ground. In the arrangement shown, as one example, main body 80 of lower support pad 18 includes a honeycomb or other inner structure having a heat reflector. However, the embodiments are not so limited. Rather, it is contemplated that in some various arrangements, lower support pad 18 may incorporate various methods and/or means for heat reflection including but not limited to, aluminum material, copper material, or any other metallic or non-metallic heat reflective material, and/or any other method and/or means for heat reflection.

### Upper Support Pad 16:

In the arrangement shown, as one example, upper support pad 16 has a generally planar rectangular shape configured to fit over heating layer 12 and main body 80 and connect with flange 92 of lower support pad 18 to encase heating layer 12.

In this example arrangement, upper support pad 16, has a generally planar rectangular shaped main body 110 having an upper surface 112 and a lower surface 114 extending between a front edge 116, a rear edge 118, and opposing side edges 120. In this example arrangement, upper support pad 16 has sidewalls 124 that extend downward from edges 116, 118, and 120 and a flange 122 that extends outward from sidewalls 124 to an outer front edge 126, an outer rear edge 128, and an outer side edges 130. In this example arrangement, outer front edge 126, outer rear edge 128, and outer side edges 130 of upper support pad 16 generally align with outer front edge 94, outer rear edge 96, and outer side edges 98 of flange 92 of lower support pad 18, respectively.

In this example arrangement, a lower surface of flange 122 of upper support pad 16 is connected to an upper surface of flange 92 of lower support pad 18 to encase and seal heating layer 12 between upper support pad 16 and lower support pad 18 with heating layer 12 positioned between upper surface 82 of lower support pad 18 and lower surface 114 of upper support pad 16. In some various arrangements, upper support pad 16 and lower support pad 18 may be connected using various means and methods known in the art including but not limited to, for example: adhesive bonding, chemical bonding, welding, and/or mechanical attachment means such as screws, bolts, threading, interlocks, clips, pins, or other coupling devices.

In various different arrangements, upper support pad 16 and lower support pad 18 may be formed of various different materials. In one or more arrangements, upper support pad 16 and lower support pad 18 are formed of a hard or rigid material (e.g., thermoplastic polyolefin or other plastic, metal, and/or composite material). This combination of using a hard or rigid plastic, metal, or composite material provides a strong, durable, and long lasting mat that can handle daily use and abuse without significant wear or damage to the heating layer 12. In one or more arrangements, upper support pad 16 may additionally or alternatively include materials configured to absorb infrared heat and thereby provide more heat at the upper surface 112 of main body 110 of upper support pad 16.

Although hard materials help to protect heating layer 12, one drawback of using such materials is that these materials tend to have a low coefficient of friction. As a result, the system 10 may slide more easily on the floor and/or objects placed on top of the heating mat system 10 may slide more easily. Such movement can cause an injury to a user.

In one or more arrangements, lower surface 84 of main body 80 of lower support pad 18 and/or upper surface 112 of main body 110 of upper support pad 16 may be textured or include one or more grip pads 134 configured to increase friction and/or prevent slipping.

Grip pads 134 are formed of any suitable size, shape, and design and of any material that that has a higher coefficient of friction than the material of the surface on which grip pads 134 are positioned upon to facilitate improved grip of system 10 with surfaces of other objects during use. In various arrangements, grip pads 134 may be formed of various materials including but not limited to, for example, a rubber material, a natural rubber material, a synthetic rubber material, a silicone material, an isoprene rubber material, an ethylene propylene diene (EPDM) material, a nitrile rubber (NBR) material, a styrene butadiene rubber (SBR) material, a silicone rubber material, a butyl rubber material, a isobutylene isoprene rubber material, a polybutadiene rubber material, a foam rubber material, any compressible or high coefficient of friction plastic material, or any other material that is more-compressible than and/or has a higher coefficient of friction than the rigid materials used to form upper support pad 16 and/or lower support pad 18.

### Control System 200:

In one or more arrangements, system 10 may be controlled using various means and/or methods to provide a desired temperature output. In one or more arrangements, system 10 includes a control system 200 configured to adjust temperature by adjusting the voltage and/or current that is applied to electric contacts 34 and 36. Additionally or alternatively, in one or more arrangements, control system 200 may be configured to connect and disconnect a power source to/from electric contacts 34 and 36. For example, in one or more arrangements, system 10 may include a relay switch 198 (not shown) configured to connect and disconnect a power source to/from electric contacts 34 and 36 in response to a control signal from control system 200. As an illustrative example, control system 200 may be configured to adjust temperature output by system 10 by adjusting the amount of time that the power source is connected to electric contacts 34 and 36. For example, control system 200 may connect the power source to electric contacts 34 and 36 for 1 second every 10 seconds when operated at a lower temperature setting and connect the power source to electric contacts 34 and 36 for 1 second every 5 seconds at a higher temperature setting. Additionally or alternatively, on one or more arrangements, control system 200 may be configured to connect and disconnect a power source to/from electric contacts 34 and 36 in response to readings of a temperature sensor to maintain a desired output temperature.

Control system 200 is formed of any suitable any suitable size, shape, and design and is configured to control operation of system 10. In the arrangement shown, as one example, control system 200 includes a control circuit 202, user interface 204, and/or sensors 206, among other components.

### Control Circuit 202:

Control circuit 202 is formed of any suitable size, shape, design and is configured to control operation of various components of system 10 in response to signals of sensors 206 and/or input from user interface 204. In the arrangement shown, as one example, control circuit 202 includes a communication circuit 210, a processing circuit 212, and a memory 214 having software code 216 or instructions that facilitate the operation of system 10.

Processing circuit 212 may be any computing device that receives and processes information and outputs commands according to software code 216 stored in memory 214. For example, in some various arrangements, processing circuit 212 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 214. Memory 214 may be any form of information storage such as flash memory, ram memory, dram memory, a hard drive, or any other form of memory.

Processing circuit 212 and memory 214 may be formed of a single combined unit. Alternatively, processing circuit 212 and memory 214 may be formed of separate but electrically connected components. Alternatively, processing circuit 212 and memory 214 may each be formed of multiple separate but communicatively connected components.

Software code 216 is any form of instructions or rules that direct how processing circuit 212 is to receive, interpret and respond to information to operate as described herein. Software code 216 or instructions are stored in memory 214 and accessible to processing circuit 212. As an illustrative example, in one or more arrangements, software code 216 or instructions may configure processing circuit 212 of control circuit 202 to monitor sensors 206 and perform various preprogramed actions in response to signals from sensors 206 satisfying one or more trigger conditions.

As some illustrative examples, some actions that may be initiated by control circuit 202 in response to signals from sensors 206 and/or user input from user interface 204 include but are not limited to, for example, connecting and disconnecting electric contacts 34 and 36 to/from a power source, controlling voltage and/or current provided by the power source to electric contacts 34 and 36, otherwise controlling output temperature provided by system 10, and/or sending notifications to users (e.g., emails, SMS, push notifications, automated phone call, social media messaging, and/or any other type of messaging) regarding operation of system 10 and/or management of livestock.

Communication circuit 210 is formed of any suitable size, shape, design, technology, and in any arrangement and is configured to facilitate communication with devices to be controlled, monitored, and/or alerted by control system 200. In one or more arrangements, as one example, communication circuit 210 includes a transmitter (for one-way communication) or transceiver (for two-way communication). In various arrangements, communication circuit 210 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/ WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Sensors 206:

Sensors 206 are formed of any suitable size, shape, design, technology, and in any arrangement and are configured to measure factors pertaining to operation of system 10 and/or monitoring and/or management of livestock. In some various arrangements, sensors 206 may include but are not limited to, for example, temperature sensors, voltage sensors, current sensors, location sensors (e.g., GPS sensors), position sensors, switches, motion sensors, speed sensors, proximity sensors, light sensors, cameras, microphones, LIDAR, speed sensors, humidity sensors, moisture sensors, fuel and/or energy sensors, and/or any other type of sensor, and/or various combinations thereof.

In some arrangements, sensors 206 may be formed along with control circuit 202 as a single combined unit. Alternatively, in some arrangements sensors 206 and control circuit 202 may be communicatively connected by communication circuit 210.

### User Interface 204:

User interface 204 is formed of any suitable size, shape, design, technology, and in any arrangement and is configured to facilitate user control and/or adjustment of various components of system 10. In one or more arrangements, as one example, user interface 204 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 204 includes a display (not shown). The display is formed of any suitable size, shape, design, technology, and in any arrangement and is configured to display information of settings, sensor readings, time elapsed, and/or other information pertaining to operation or system 10 and/or management of livestock. In one or more arrangements, the display may include, for example, LED lights, meters, gauges, screen or monitor of a computing device, tablet, and/or smartphone.

As an illustrative example, in one or more arrangements system 10 may include one or more LEDs positioned on a housing (not shown) that are configured to light up when system 10 is in operation. Such visual indication of when system 10 is in operation may be useful to assist an operator in monitoring and/or reviewing the status of system 10 as infrared heat generated by system 10 may not be easily visible. Such a visual indicator may help avoid unintended operation of system 10 (e.g., accidentally leaving system 10 on when operation is not intended). In one or more arrangements, the display of system 10 may additionally or alternatively be configured to provide a visual indicator indicating a heat and/or temperature setting of system.

Additionally, or alternatively, in one or more arrangements, the inputs and/or the display may be implemented on a separate device that is communicatively connected to control circuit 202. For example, in one or more arrangements, operation of control circuit 202 may be customized or controlled using a smartphone or other computing device that is communicatively connected to the control circuit 202 (e.g., via Bluetooth, WIFI, and/or the internet).

From the above discussion it will be appreciated that the heating mat system presented herein improves upon the state of the art. More specifically, and without limitation, it will be appreciated that in one or more arrangements a system is presented: that is safe to use; that is less susceptible to damage; that provides more uniform heat distribution; that is configured for use in livestock operations; that is easy to deploy; that is easy to install; that has a long useful life; that is durable; that has a robust design; that is self-healing; that is easy to use; and/or that is high quality. Example embodiments of the invention have been described in an illustrative manner. It is to be understood that the terminology that has been used is intended to be in the nature of words of description rather than of limitation. It will be appreciated by those skilled in the art that other various modifications could be made to the device without parting from the spirit and scope of this disclosure. All such modifications and changes fall within the scope of the claims and are intended to be covered thereby.

What is claimed:

1. A heating mat system, comprising:
a heating layer;
the heating layer having a conductive microfilm;
the conductive microfilm having a generally planar shape extending between a front edge, a rear edge, and opposing side edges;
wherein the conductive microfilm includes a layer of graphene;
a first electrical contact connected to the conductive microfilm;
a second electrical contact connected to the conductive microfilm;
an upper support pad;
a lower support pad;
wherein the heating layer is positioned between the upper support pad and the lower support pad;
wherein application of a voltage difference between the first electrical contact and the second electrical contact causes current to flow through the conductive microfilm, thereby generating heat.

2. The system of claim 1, wherein the conductive microfilm includes a plurality of layers of graphene.

3. The system of claim 1, wherein the conductive microfilm includes a stack of eight layers of graphene.

4. The system of claim 1, wherein the conductive microfilm includes a carbon silver nanomaterial mixture.

5. The system of claim 1, wherein the conductive microfilm has a non-continuous pattern.

6. The system of claim 1, wherein the conductive microfilm has a honey-comb pattern.

7. The system of claim 1, wherein the conductive microfilm is self-healing.

8. The system of claim 1, wherein the layer of graphene distributes heat to portions of the layer of graphene where less current flows to provide even heat distribution.

9. The system of claim 1, wherein the heating layer includes an upper substrate layer and a lower substrate layer;
wherein the conductive microfilm is positioned between the upper substrate layer and the lower substrate layer.

10. The system of claim 1, wherein the heating layer includes an upper substrate layer and a lower substrate layer;
wherein the conductive microfilm is positioned between the upper substrate layer and the lower substrate layer;
wherein the upper substrate layer and the lower substrate layer are a plastic film.

11. The system of claim 1, wherein the lower support pad includes an insulated portion.

12. The system of claim 1, wherein the lower support pad includes a heat reflector.

13. The system of claim 1, wherein the current that flows through the conductive microfilm causes the conductive microfilm to emit infrared radiation.

14. The system of claim 1, wherein the current that flows through the conductive microfilm causes the conductive microfilm to emit infrared radiation; and
wherein the upper support pad includes a material configured to absorb the infrared radiation.

15. The system of claim 1, wherein an upper surface of the upper support pad has a grip pad.

16. The system of claim 1, wherein a lower surface of the lower support pad has a grip pad.

17. The system of claim 1, wherein the upper support pad has a textured upper surface.

18. The system of claim 1, wherein the lower support pad has a textured lower surface.

19. A livestock heating method, comprising:
providing a heating mat having a heating layer positioned between an upper support pad and a lower support pad;
the heating layer including a conductive microfilm;
the conductive microfilm having a generally planar shape extending between a front edge, a rear edge, and opposing side edges;
wherein the conductive microfilm includes a layer of graphene;
wherein the heating mat includes a first electrical contact connected to the conductive microfilm;
wherein the heating mat includes a second electrical contact connected to the conductive microfilm;
generating heat by applying a voltage difference between the first electrical contact and the second electrical contact to induce electric current to flow through the conductive microfilm, thereby generating heat.

20. The method of claim 19, wherein the conductive microfilm includes one or more layers of graphene.

21. The method of claim 19, wherein the heating layer includes an upper substrate layer and a lower substrate layer;
wherein the conductive microfilm is positioned between the upper substrate layer and the lower substrate layer;
wherein the upper substrate layer and the lower substrate layer are a plastic film.

22. The method of claim 19, wherein the lower support pad includes an insulated portion.

23. The method of claim 19, wherein the upper support pad includes a material configured to absorb infrared radiation.

24. The method of claim 19, wherein an upper surface of the upper support pad has a grip pad;
wherein a lower surface of the lower support pad has a grip pad.

25. The method of claim 19, wherein the upper support pad has a textured upper surface;
wherein the lower support pad has a textured lower surface.

26. A heating mat system, comprising:
a heating layer;
the heating layer having a conductive microfilm;
the conductive microfilm having a generally planar shape extending between a front edge, a rear edge, and opposing side edges;
wherein the conductive microfilm includes a layer of graphene;
a first electrical contact connected to the conductive microfilm;
a second electrical contact connected to the conductive microfilm;
an upper support pad;
a lower support pad;
wherein the heating layer is positioned between the upper support pad and the lower support pad;
wherein application of a voltage difference between the first electrical contact and the second electrical contact causes current to flow through the conductive microfilm, thereby generating heat;
a control system operably connected to the heating layer;
wherein when the control system is operated, the control system adjusts the heat generated by the system by adjusting the voltage difference applied to the first electrical contact and the second electrical contact.

27. The system of claim 26, wherein the control system includes one or more sensors configured to measure factors pertaining to operation of the system;
wherein the one or more sensors are operably connected to the control system; and
wherein the control system responds to information received from the one or more sensors.

28. A heating mat system for warming piglets, the system comprising:
an upper surface;
a lower surface;
a layer of graphene;
wherein the layer of graphene is positioned between the upper surface and the lower surface;
wherein when a voltage is applied across the layer of graphene, the layer of graphene generates heat thereby warming piglets when they are on the heating mat system.
